(19) United States
(12) Patent Application Publication
(10) Pub. No.: US 2011/0199624 A1
(43) Pub. Date: Aug. 18, 2011

(54) METHOD AND APPARATUS FOR PROCESSING IMAGE

(75) Inventor: Kiyoshi Iwaki, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/021,066

(22) Filed: Feb. 4, 2011

Related U.S. Application Data
(60) Provisional application No. 61/303,912, filed on Feb. 12, 2010.

(51) Int. Cl. G06F 15/00

(52) U.S. Cl. 358/1.9

(57) ABSTRACT

According to one embodiment, an image processing apparatus including a preview image creating section configured to create a preview image corresponding to image data, a display section configured to display the preview image, an additional image input section configured to acquire and store image data to be added to the preview image displayed by the display section, and an image synthesizing section configured to superimpose the image data to be added to the preview image by the additional image input section on the image data used in forming the preview image.

### CROSS-REFERENCE TO RELATED APPLICATIONS

This application is based upon and claims the benefit of priority from: U.S. Provisional Application No. 61/303,912 filed on Feb. 12, 2010, the entire contents of each of which are incorporated herein reference.

### FILED

Embodiments described herein relates generally to an image processing method and an image processing apparatus.

### BACKGROUND

An image forming apparatus called MFP (Multi-Functional Peripheral) forms a visible image corresponding to image data and outputs the visible image onto a sheet medium as an output image (a printout). The output image can involve, for example, a security code or a watermark independently from the image data.

However, security codes, watermarks, and the like are prepared as, for example, templates in an MFP main body. Therefore, when image data and a security code, a watermark, or the like are superimposed, a degree of freedom of superimposition is limited. Therefore, if it is desired to obtain a high degree of freedom, it is necessary to once output an output image and write a security code, a watermark, or the like in the output image. The security code, the watermark, or the like remains in the output image prepared for the writing of the security code, the watermark, or the like.

### BRIEF DESCRIPTION OF THE DRAWINGS

FIG. 1 is an exemplary diagram showing an example of an MFP according to an embodiment;

FIG. 2 is an exemplary diagram showing a display example of a display (a touch panel) of a user interface section at a point when the MFP is started according to an embodiment;

FIG. 3 is an exemplary diagram showing an example of a state in which an edit mode is started when the MFP can perform copying according to an embodiment;

FIG. 4 is an exemplary diagram showing an example of a state in which the MFP shifts to “SYNTHETIC” in which image synthesizing is possible according to an embodiment;

FIG. 5 is an exemplary diagram showing an example of a state in which an image to be superimposed and an original image are synthesized in a state in which image synthesizing is possible according to an embodiment; and

FIG. 6 is an exemplary diagram showing an example of image synthesizing in terms of software in the MFP according to an embodiment.

### DETAILED DESCRIPTION

In general, according to an embodiment, an image processing apparatus comprising: a preview image creating section configured to create a preview image corresponding to image data; a display section configured to display the preview image; an additional image input section configured to acquire and store image data to be added to the preview image displayed by the display section; and an image synthesizing section configured to superimpose the image data to be added to the preview image by the additional image input section on the image data used in forming the preview image.

Embodiments will now be described hereinafter in detail with reference to the accompanying drawings.

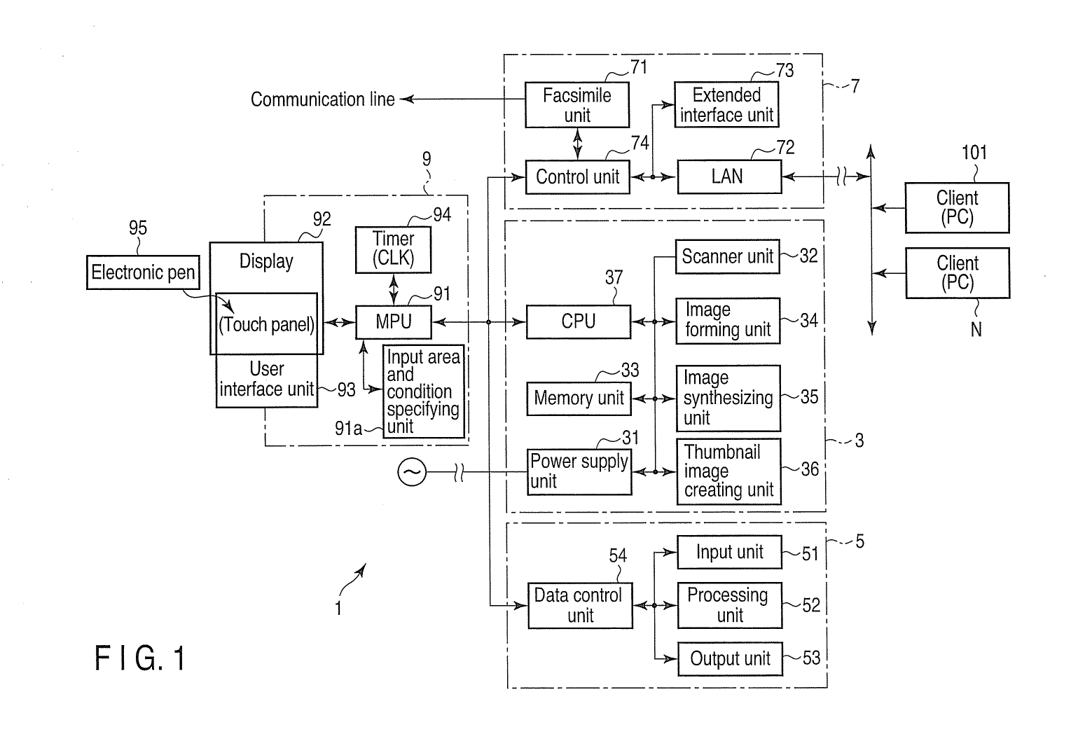

FIG. 1 shows an example of an outline of a MFP (Multi-functional Peripheral, an electronic apparatus).

An MFP 1 includes at least an image forming section 3, a data managing section 5, a communication control section 7, and a system control section 9.

The image forming section 3 visualizes an image and a character on the basis of data of an arbitrary format and outputs the visualized image and character onto a sheet medium. The data managing section 5 receives data and manages the data for execution of jobs such as print output and storage. The communication control section 7 manages transmission and reception of data between the MFP 1 and a communication line (a network). The system control section 9 controls the operation of the image forming section 3, the data managing section 5, and the communication control section 7, i.e., the MFP 1.

The image forming section 3 includes a power supply unit 31, a scanner unit 32, a memory unit 33, an image forming unit 34, an image synthesizing unit 35, a thumbnail image creating unit 36, and a CPU (a microprocessor) and includes at least a process control unit (a process controller) 37 configured to control the units of the image forming section 3.

The power supply unit 31 is connected to a commercial power supply and generates a secondary side voltage used for the operation of the MFP 1 from a primary side voltage. It goes without saying that the power supply unit 31 manages, concerning the primary side voltage, an input allowable current.

If information such as an image or a character or information such as a shape or a color to be visualized and output onto a sheet medium by the image forming unit 34 is in a non-data format, the scanner unit 32 outputs the information as image data. The scanner unit 32 irradiates light on a sheet-like document or a three-dimensional object including the information, acquires an electric signal corresponding to the intensity of light (image light) of the light reflected on the information, and converts the electric signal into image data.

The memory unit 33 stores the image data obtained by the scanner unit 32, image data input from the outside such as output data from a personal computer (PC) or facsimile reception data, and superimposition image data, for example, color marking data or an underline input by a user, or a security code, a watermark, or the like prepared in advance. The memory unit 33 also stores a computer program or an application (software).

The image forming unit 34 visualizes the image data and outputs the image data onto a sheet medium. As a visualization method, an electrostatic transfer system for visualizing the image data using a toner or a direct recording system for visualizing the image data using ink is often used. A hot stamp or the like may also be used for output of special colors (gold and silver).

The image synthesizing unit 35 superimposes, in the memory unit 33, the image data read by the scanner unit 32, the output data from the PC, the facsimile reception data, or the like and the superimposition data such as the color marking data or the underline input by the user, or the security code, the watermark, or the like prepared in advance. As the image data, a thumbnail image created by the thumbnail image creating unit 36 is used. The image synthesizing unit 35 displays the image data on a display 92 of the system control section 9 and superimposes and displays, on the display 92, the superimposition data such as the color marking data or the underline input by the user or the security code, the watermark, or the like prepared in advance.

The thumbnail image creating unit 36 generates a thumbnail image (a preview image), which is magnified at a predetermined magnification, for displaying, on the display 92 of the system control section 9, at least image data for one page of the image data read by the scanner unit 32, the output data from the PC, or the facsimile reception data. When the image synthesizing is instructed via the system control section 9, the thumbnail image creating unit 36 creates a thumbnail image corresponding to the superimposition image data such as the color marking data or the underline input by the user or the security code, the watermark, or the like prepared in advance and displays the thumbnail image on the display 92 while superimposing the thumbnail image on the image data.

The image forming section 3 stores an image output by the image forming unit 34 and includes a feeding mechanism for a sheet medium to be fed to the image forming unit 34.

The data managing section 5 includes at least a data input unit 51 configured to receive data, a data processing unit 52 configured to process, for execution of jobs such as print output and storage, the data received by the data input unit 51, a data output unit 53 configured to output, in a format specified by a job, the data processed by the data processing unit 52, and a data control unit (a data controller) 54 configured to control exchange of the data among the data input unit 51, the data processing unit 52, and the data output unit 53.

The communication control section 7 includes at least a facsimile (communication) unit 71 connected to a public communication line and configured to receive facsimile data and transmit the facsimile data, a LAN (communication) unit 72 connected to an external network, for example, a LAN (Local Area Network) and configured to receive data from a network or transmit data to the network, an extended interface unit 73 conforming to, for example, the USB (Universal Serial Bus) standard and configured to receive data from the other party to be connected or transmit data to the party, and a communication control unit (a communication controller) 74 configured to control communication with the party, input and output of the data, parallel processing, and the like by each of the facsimile (communication) unit 71, the LAN (communication) unit 72, and the extended interface unit 73.

The system control section 9 includes at least a main control block (an MPU) 91 and a user interface unit 93 (to which the display 92 integrally including a touch panel (an input unit or an input panel area) is connected). The MPU 91 is interconnected to a process controller 37, the data controller 54, and a communication controller 74 of the sections/units explained above and controls the sections/units.

The MPU 91 is connected to the user interface unit 93. The MPU 91 outputs, while receiving instruction inputs for executing start and stop of the operations of the sections/unit, condition setting, superimposition of the superimposition data, i.e., the color marking data, the under line, the security code, or the watermark, and the like from the touch panel (the input panel area) of the display 92, control signals for controlling the operations of the sections/unit according to the instruction inputs.

The touch panel (the display) 92 detects an instruction (control) input by a touch of a finger of the user or an electronic pen (e-pen) 95 prepared in advance and inputs (instructs), for example, start of copying or scanning, display of scan data or facsimile data, start of the image synthesizing or the like to the MPU 91.

The instruction (control) input by the electronic pen 95 includes information such as a position and a range on the display 92 and, for example, thickness and a color of a line specified by, for example, an input area and condition specifying processing unit 91a connected to the MPU 91 or an application stored as firmware of the MPU 91. Information already input can be erased.

The MPU 91 is connected to a timer unit 94. The timer unit 94 stores year (yyyy), month (mm), day (DD), hour (HH), and minute (MM) with reference to a clock generated by a clock generating unit (CLK) incorporated in the timer unit 94. For operation of the MPU 91, the clock generating unit (CLK) may be provided in the system control section 9. For counting of time or storage of time data by the timer unit 94, for example, the frequency of the commercial power supply input to the power supply unit 31 of the image forming section 3 may be used or time data (a time-information service signal) included in a broadcast signal (of a space wave) may be directly received.

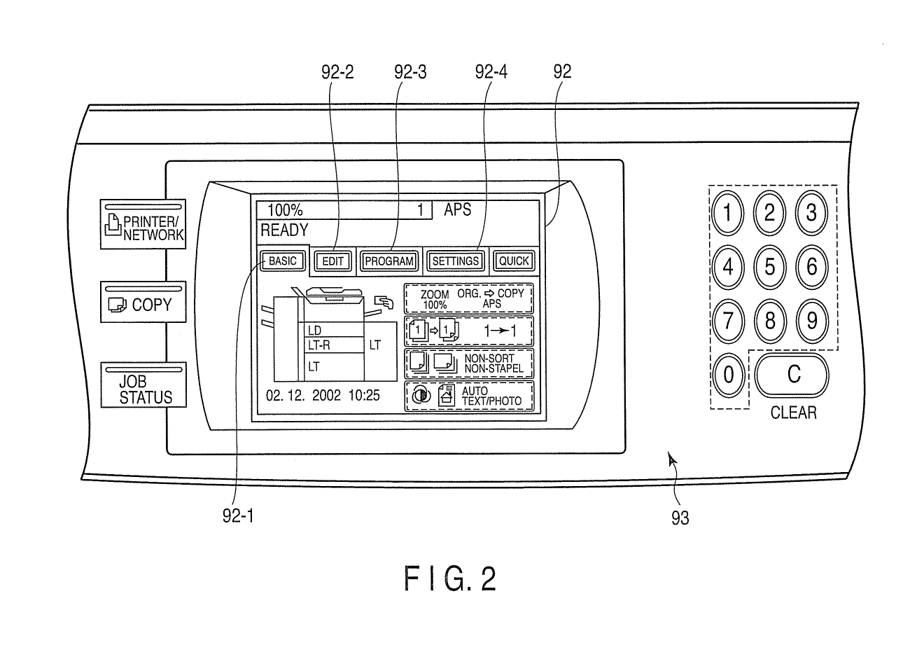

FIG. 2 shows a display example of the display (the touch panel) 92 of the user interface unit 93 at a point when the MFP 1 is started.

When the MFP 1 is started, the MFP 1 warms up in a general copying mode and changes to a standby state.

FIG. 2 shows a state in which mode selection button indicators are displayed. The mode selection button indicators include a “BASIC” indicator 92-1 for enabling copying, an “EDIT” indicator 92-2 for enabling setting of editing modes such as image synthesizing during copying, image synthesizing for scan data or facsimile data, and partial erasing, a “PROGRAM” indicator 92-3 started during addition, deletion, and update of a computer program, and a “SETTING” indicator 92-4 for enabling, for example, a change of an operation condition (setting) for the user and an administrator. The indicators shown in FIG. 2 are displayed on the basis of, for example, font data and GUI (Graphical User Interface) data (including display rules) stored by the memory unit 33. The data and the display rules (the GUI data) for the indicators may be firmware of the MPU 91. The data and the display rules for the indicators can be updated through, for example, the extended interface unit 73.

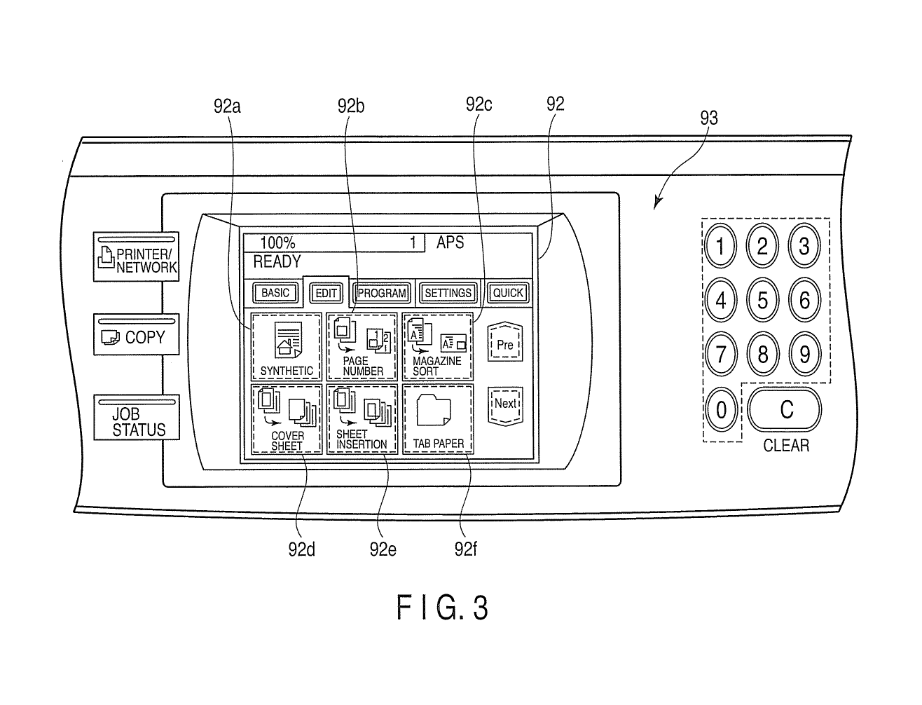

FIG. 3 shows a state in which the edit mode is started by an instruction (selection) input by the “EDIT” indicator 92-2 in the standby state (a state in which it is notified by the “BASIC” indicator 92-1 that copying is possible in FIG. 2) of the MFP 1. Initial (default) display of the edit mode includes, for example, a “SYNTHETIC” indicator 92a for enabling image synthesizing, a “PAGE NUMBER” indicator 92b for starting a page display mode for automatically outputting page indication to an output image, a “MAGAZINE SORT” indicator 92c for starting a magazine sort mode for collecting plural image data (for plural pages) in one output image, a “COVER SHEET” indicator 92d for starting a front cover addition mode for adding a cover sheet, a “SHEET INSERTION” indicator 92e for starting a sheet addition mode for adding another sheet medium in an arbitrary position of two or more output images, and a “TAB PAPER” indicator 92f for starting a tab sheet addition mode for adding a sheet with tab.

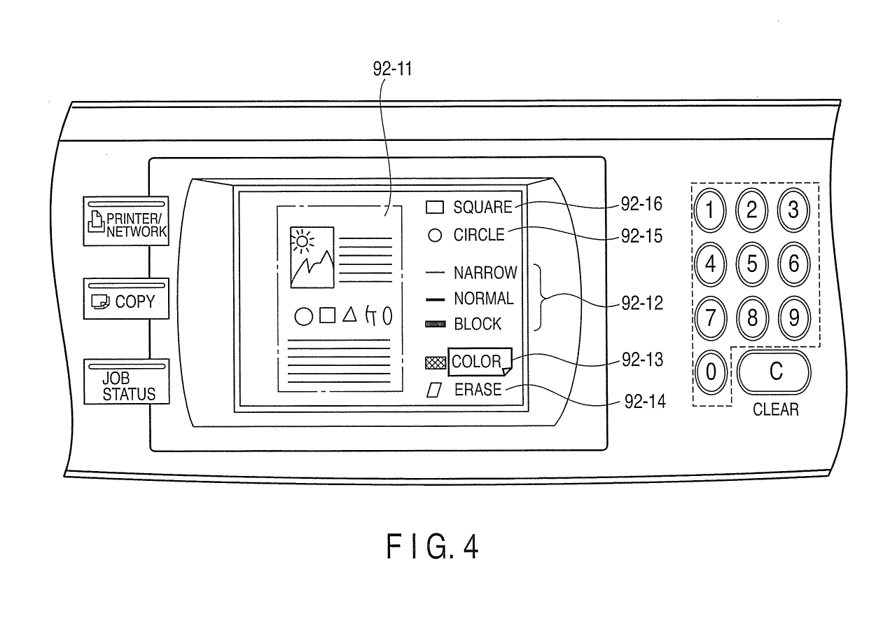

As indicated by an example shown in FIG. 4, in the initial (default) display of the edit mode shown in FIG. 3, for example, if the “SYNTHETIC” indicator 92a for enabling image synthesizing is selected, the display (the touch panel) 92 displays, in predetermined size, the original image data such as the image data read by the scanner unit 32, the output data from the PC, or the facsimile reception data (displays a preview image) on a display area 92-11. The preview image is an image obtained by the thumbnail image creating unit 36 generating the original image data such as the image data read by the scanner unit 32, the output data from the PC, or the facsimile reception data as a thumbnail image magnified at the predetermined magnification. During image synthesizing, the display 92 displays, in the same display, a “TYPE” indicator 92-12 (thickness of a line), a “COLOR” indicator 92-13 (a color of a line), an “ERASE” indicator 92-14 (erase or reset), an “CIRCLE” indicator 92-15 (input for circle), and the like to enable selection input of the data and the display rules (the GUI data) for display that can be input by the electronic pen (e-pen) 95, for example, thickness of a line (an underline) and color marking data or the superimposition image data such as the security code and the watermark prepared in advance. The superimposition image data can also be displayed (located) in a predetermined position of the original image data by, for example, selecting, with the electronic pen (e-pen) 95, the “CIRCLE” indicator 92-15 (circle) for preparing a circle, a “SQUARE” indicator 92-16 for preparing a square, or the like and displaying a ‘circle’ or a ‘square’ in an arbitrary position, changing the position (moving a display position) with a finger (of the user), and instructing, with at least two fingers, expansion (e.g., widening a space between the fingers from a touched position) or reduction (narrowing the space between the fingers from the touched position).

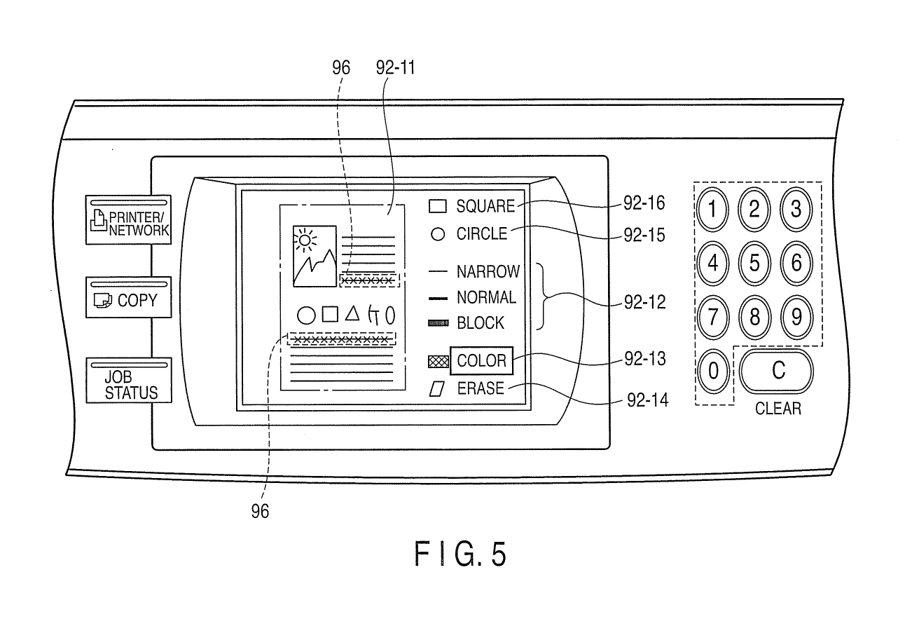

FIG. 5 shows a state in which the “SYNTHETIC” indicator 92a shown in FIG. 4 is selected and the original image data such as the image data read by the scanner unit 32, the output data from the PC, or the facsimile reception data is colored by the electronic pen 95 selected to perform coloring.

The display in FIG. 5 is a ‘thumbnail image’ obtained by changing, with the thumbnail image creating unit 36, the output image data synthesized by the image synthesizing unit 35 to a preview image according to the preview image of the original image data displayed in the display area 92-11 and position information in which the input area and condition specifying processing unit 91a specifies a range of coloring instructed (input) according to an input (coloring) instruction by the electronic pen 95.

A display example of FIG. 5 is an example of linear coloring. However, a ‘circle’, ‘handwriting (curve)’, and the like initially disclosed in Provisional Application No. 61/303,912 can also be synthesized.

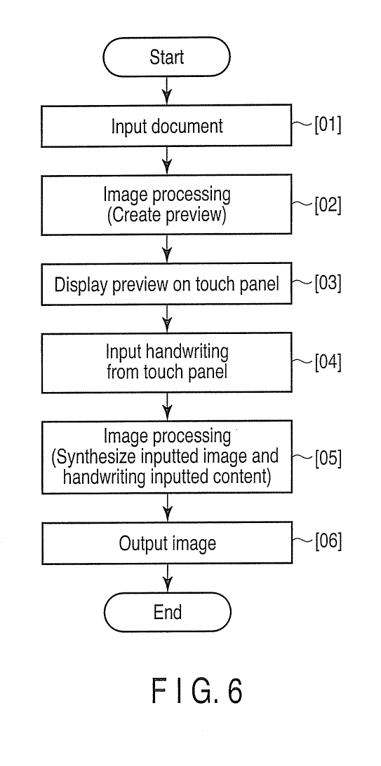

FIG. 6 shows, in terms of software, the image synthesizing (superimposition) shown in FIGS. 4 and 5.

In a state in which an image synthesizing mode is started, the original image data such as image data of an original document (the image data read by the scanner unit 32), the output data from the PC, or the facsimile reception data is prepared (stored in the memory 33) [01] and a preview image is created [02].

The created preview image corresponding to the (original) image data is displayed in the predetermined area (92-11) of the touch panel (the display) 92 [03].

An image to be superimposed on the preview image displayed by the touch panel (the display) 92 is set (input) according to a change in the position of the electronic pen (e-pen) 95 or the finger of the user [04].

The position and the size of the set (input) image to be superimposed (synthesized) and conditions (identification information such as a line, a circle, and a color) are specified [05] and the image is output as an output image [06]. The output image (the synthesized image data) can be stored in the memory unit 33 without being printed out.

As explained above, when the original image data and the security code, the watermark, or the like are superimposed, a high degree of freedom is obtained (a degree of freedom is not limited). It is unnecessary to once output the output image (print out the output image) for image synthesizing (superimposition).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a preview image creating section configured to create a preview image corresponding to image data;
a display section configured to display the preview image;
an additional image input section configured to acquire and store image data to be added to the preview image displayed by the display section; and
an image synthesizing section configured to superimpose the image data to be added to the preview image by the additional image input section on the image data used in forming the preview image.

2. The apparatus of claim 1, wherein the additional image input section includes a touch panel formed integrally with the display section.

3. The apparatus of claim 2, further comprising:
an input range and condition specifying section configured to specify a positional relation between the image data input by the additional image input section and the image data used in forming the preview image, sizes of the image data, and a condition for an additional image.

4. The apparatus of claim 1, further comprising:
an input range and condition specifying section configured to specify a positional relation between the image data input by the additional image input section and the image data used in forming the preview image, sizes of the image data, and a condition for an additional image.

5. The apparatus of claim 3, wherein the input range and condition specifying section acquires a position signal generated by an electronic pen and a selected condition.

6. The apparatus of claim 3, wherein the input range and condition specifying section acquires, from input to the touch panel, a change in the position and a change in the size of the image data input by the additional image input section.

7. The apparatus of claim 3, wherein the input range and condition specifying section acquires a position signal generated by an electronic pen and a selected condition.

8. The apparatus of claim 4, wherein the input range and condition specifying section acquires, from input to the touch panel, a change in the position and a change in the size of the image data input by the additional image input section.

9. An image forming apparatus comprising:
a preview image creating section configured to create a preview image corresponding to image data;
a display section configured to display the preview image;
an additional image input section configured to acquire and store image data to be added to the preview image displayed by the display section;
an image synthesizing section configured to superimpose the image data to be added to the preview image by the additional image input section on the image data used in forming the preview image; and
an image output section configured to form a visible image corresponding to image data superimposed by the image synthesizing section and fix the visible image on a sheet medium.

10. The apparatus of claim 9, wherein the additional image input section includes a touch panel formed integrally with the display section.

11. The apparatus of claim 9, further comprising:
an input range and condition specifying section configured to specify a positional relation between the image data input by the additional image input section and the image data used in forming the preview image, sizes of the image data, and a condition for an additional image.

12. The apparatus of claim 9, further comprising:
an input range and condition specifying section configured to specify a positional relation between the image data input by the additional image input section and the image data used in forming the preview image, sizes of the image data, and a condition for an additional image.

13. The apparatus of claim 11, wherein the input range and condition specifying section acquires, from input to the touch panel, a change in the position and a change in the size of the image data input by the additional image input section.

14. The apparatus of claim 11, wherein the input range and condition specifying section acquires, from input to the touch panel, a change in the position and a change in the size of the image data input by the additional image input section.

15. The apparatus of claim 12, wherein the input range and condition specifying section acquires a position signal generated by an electronic pen and a selected condition.

16. The apparatus of claim 12, wherein the input range and condition specifying section acquires, from input to the touch panel, a change in the position and a change in the size of the image data input by the additional image input section.

17. A method of image processing comprising:
forming a preview image corresponding to image data;
displaying the preview image;
acquiring image data to be added to the preview image; and
superimposing the image data to be added to the preview image on the image data used in forming the preview image.

18. The method of claim 17, wherein the image data to be added to the preview image is supplied through a touch panel formed integrally with a display mechanism configured to display the preview image.

19. The method of claim 18, wherein the image data to be added to the preview image includes at least one of a positional relation with the image data used in forming the preview image, sizes of the image data, and a condition for an additional image.

20. The method of claim 17, wherein the image data to be added to the preview image includes at least one of a positional relation with the image data used in forming the preview image, sizes of the image data, and a condition for an additional image.
